(19) United States
(12) Patent Application Publication
(10) Pub. No.: US 2016/0297389 A1
(43) Pub. Date: Oct. 13, 2016

(54) SEATBELT DEVICE

(71) Applicant: KABUSHIKI KAISHA TOKAI-RIKA-DENKI-SEISAKUSHO, Aichi (JP)

(72) Inventors: Tomonari UMAKOSHI, Aichi (JP); Haruhiko HASHIMOTO, Aichi (JP); Masaru UKITA, Aichi (JP); Takahiro HAMADA, Aichi (JP); Shinichi OKUBO, Aichi (JP)

(21) Appl. No.: 15/100,500

(22) PCT Filed: Oct. 28, 2014
(86) PCT No.: PCT/JP2014/078650

§ 371 Date: May 31, 2016

(30) Foreign Application Priority Data
Dec. 4, 2013 (JP) 2013-251327

(51) Int. Cl. B60R 21/18; B60R 21/231; B60R 22/12

(52) U.S. Cl. CPC B60R 21/18; B60R 22/12; B60R 21/231; B60R 2021/0032

(57) ABSTRACT

A seatbelt device is obtained that is capable of suppressing kinking of an airbag at an edge portion of webbing as kinking starting position when an occupant presses the inflating and deploying airbag. A seatbelt device 10 includes webbing 24 that is worn over a body of an occupant sitting on a seat 12, and an airbag 34 that is attached to the webbing. The airbag 34 includes an inflating portion S that inflates due to being internally supplied with gas, and first island portions 40 and a second island portion 42 that are set with a smaller dimensional change in the thickness direction of the webbing 24 than the dimensional change of the inflating portion S in the thickness direction of the webbing 24 when internally supplied with gas. Moreover, the first island portions 40 and the second island portion 42 are disposed alongside width direction edge portions of the webbing 24 and are disposed facing a chest of an occupant P in an inflated state of the inflating portion S.

### TECHNICAL FIELD

The present invention relates to a seatbelt device.

### BACKGROUND ART

International Publication (WO) No. 2012/058422 describes a seatbelt device including webbing (a seatbelt) that configures lap webbing and shoulder webbing that respectively support an abdomen and a chest of an occupant, and an airbag that is attached to the shoulder webbing. In the technology described in this document, in a vehicle collision, the airbag attached to the shoulder webbing inflates and deploys in a width direction of the webbing (belt width direction), thereby enabling the chest of the occupant to be supported across a wider area.

### SUMMARY OF INVENTION

### Technical Subject

However, in the technology described in the above document, it is conceivable that the airbag could kink at a width direction edge portion of the webbing as a kinking starting position when, for example, the chest of the occupant presses the inflating and deploying airbag.

In consideration of the above circumstances, an object of the present invention is to obtain a seatbelt device capable of suppressing kinking of an airbag that is originated at a width direction edge portion of webbing when an occupant presses the inflating and deploying airbag.

### Solution to Subject

A seatbelt device of a first aspect of the present invention includes: webbing configured to be worn by an occupant sitting in a vehicle seat; and an airbag attached to the webbing, the airbag including an inflating portion that inflates due to being internally supplied with gas, and an island portion, the island portion being set with a smaller dimensional change than the inflating portion in a thickness direction of the webbing when internally supplied with gas and being disposed at a position at a side of a width direction edge portion of the webbing and facing a chest of the occupant in an inflated state of the inflating portion. The airbag deploys in a width direction of the webbing between the webbing and the occupant due to inflation of the inflating portion.

According to the seatbelt device of the first aspect, in a state in which the webbing is being worn by the occupant, when gas is supplied into the airbag, the inflating portion of the airbag inflates, and the airbag deploys in the width direction of the webbing.

When the inflating portion of the airbag inflates, namely when the airbag deploys, the island portion of the airbag is disposed alongside the width direction edge portion of the webbing and disposed at a position facing the chest of the occupant. Gas supplied inside the airbag collides with the island portion. The pressure of the gas accordingly increases in the vicinity of the island portion. This enables kinking of the airbag at a location in the vicinity of the island portion as a kinking starting position, namely kinking of the airbag that is originated at the width direction edge portion of the webbing, to be suppressed when the occupant presses the inflating and deploying airbag toward the webbing side. Moreover, the gas that has collided with the island portion flows toward the width direction of the webbing, thereby enabling improved deployment performance of the airbag in the width direction of the webbing.

A seatbelt device of a second aspect of the present invention is the seatbelt device of the first aspect, wherein the island portion overlaps with a width direction edge of the webbing as viewed along the thickness direction of the webbing.

According to the seatbelt device of the second aspect, gas pressure can be raised at locations of the airbag overlapping with the width direction edge of the webbing due to the gas colliding with the island portion. Namely, gas pressure can be raised in the vicinity of the width direction edge of the webbing that is liable to act as a kinking start position. This thereby enables the airbag to be suppressed from kinking originated at the width direction edge of the webbing.

A seatbelt device of a third aspect of the present invention is the seatbelt device of either the first aspect or the second aspect, wherein the island portion is formed in an elongated shape with its length direction along the width direction of the webbing.

According to the seatbelt device of the third aspect, the gas that has collided with the island portion flows along the length direction of the island portion, namely flows toward the width direction of the webbing, thereby enabling stable deployment performance of the airbag in the width direction of the webbing.

A seatbelt device of a fourth aspect of the present invention is the seatbelt device of any one of the first aspect to the third aspect, wherein the island portion is configured by plural first island portions provided with a spacing between each other in the width direction of the webbing, and a second island portion formed in an elongated shape running across in the width direction of the webbing. The second island portion is disposed alongside the first island portion in a length direction of the webbing.

According to the seatbelt device of the fourth aspect, the airbag can be suppressed from kinking at a location in the vicinity of the first island portions and the second island portion when the occupant presses the inflating and deploying airbag toward the webbing side. Moreover, gas flowing between the plural first island portions collides with the second island portion. The gas that has collided with the second island portion flows toward the width direction of the belt between the first island portions and the second island portion. This thereby enables improved deployment performance of the airbag in the width direction of the webbing at a location between the first island portions and the second island portion.

### Advantageous Effects of Invention

The seatbelt device according to the first aspect to the fourth aspect exhibits the excellent advantageous effect of being capable of suppressing kinking of the airbag at the width direction edge portion of webbing as the kinking starting position when an occupant presses the inflating and deploying airbag.

### BRIEF DESCRIPTION OF DRAWINGS

FIG. 1 is a front view illustrating a vehicle seat and a seatbelt device as viewed from a front side of the seat.

FIG. 2 is a front view illustrating webbing and the like in a state prior to inflation of an airbag.

FIG. 3 is a front view illustrating an airbag.

FIG. 4 is a cross-section view illustrating a cross-section of webbing and an airbag taken along line 6-6 in FIG. 3.

FIG. 5 is a cross-section view illustrating a cross-section of webbing and an airbag taken along line 4-4 in FIG. 3.

FIG. 6 is a cross-section view illustrating a cross-section of webbing and an airbag taken along line 5-5 in FIG. 3.

FIG. 7 is a view illustrating a cross-section of webbing, an airbag, and the like taken along line 7-7 in FIG. 2.

FIG. 8 is an enlarged front view illustrating an airbag.

### DESCRIPTION OF EMBODIMENTS

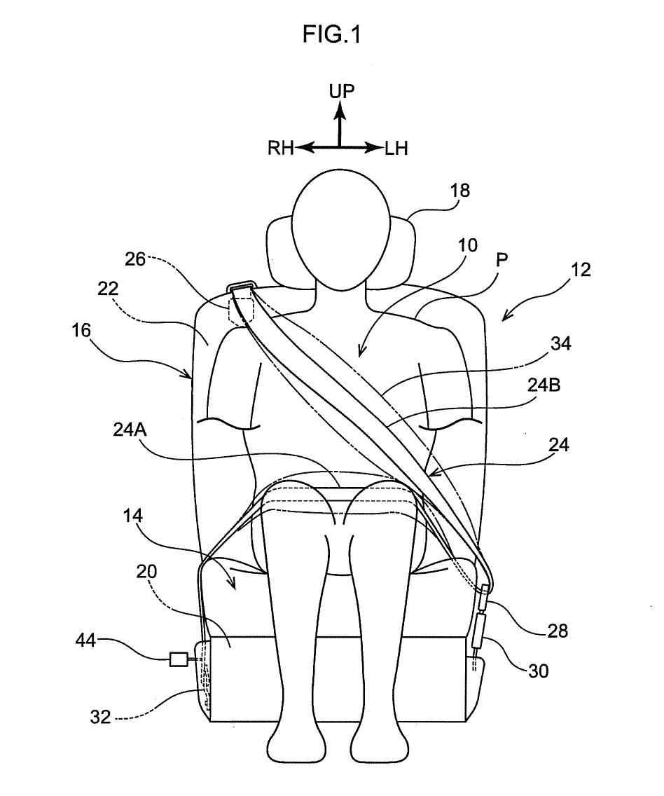

Explanation follows regarding a seatbelt device according to an exemplary embodiment of the present invention, with reference to FIG. 1 to FIG. 7. In the following explanation, the front, rear, left, right, upward and downward directions refer to the front, rear, left, right, upward and downward directions from the perspective of an occupant sitting in a vehicle seat. In the respective drawings, the arrow FR indicates the front direction, the arrow UP indicates the upward direction, the arrow RH indicates the right direction, and the arrow LH indicates the left direction, as appropriate.

As illustrated in FIG. 1, a seatbelt device 10 of the present exemplary embodiment is provided at a separate seat 12 (referred to below as simply the “seat 12”), serving as a vehicle seat provided in a second row in what is referred to as a minivan-type vehicle. Explanation is first given regarding a schematic configuration of the seat 12, followed by explanation regarding a configuration of the seatbelt device 10, this being a relevant section of the present exemplary embodiment.

### Schematic Configuration of Seat 12

The seat 12 includes a seat cushion 14 that supports the buttocks and thighs of an occupant P, a seatback 16 that supports the back of the occupant P and is reclinably attached to a rear end portion of the seat cushion 14, and a headrest 18 that supports the head of the occupant P and is attached to an upper end portion of the seatback 16.

The seat cushion 14 is configured by attaching a seat cushion pad covered by a covering material to a seat cushion frame 20. An upper rail, not illustrated in the drawings, is attached to a lower end portion of the seat cushion frame 20. The upper rail moves along a lower rail provided at a vehicle body floor so as to enable the seat 12 to slide along a vehicle front-rear direction. A buckle 30 that retains a tongue 28 is fixed to a left side of the seat cushion frame 20, and an anchor 32 that supports an end portion of webbing 24 is fixed to a right side of the seat cushion frame 20.

The seatback 16 is configured by attaching a seatback pad covered by a covering material to a seatback frame 22. A webbing take-up device 26 that takes up the webbing 24 and a shoulder anchor 27 through which the webbing 24 is inserted are fixed to an upper end portion and a right side end portion of the seatback frame 22.

### Seatbelt Device 10 Configuration

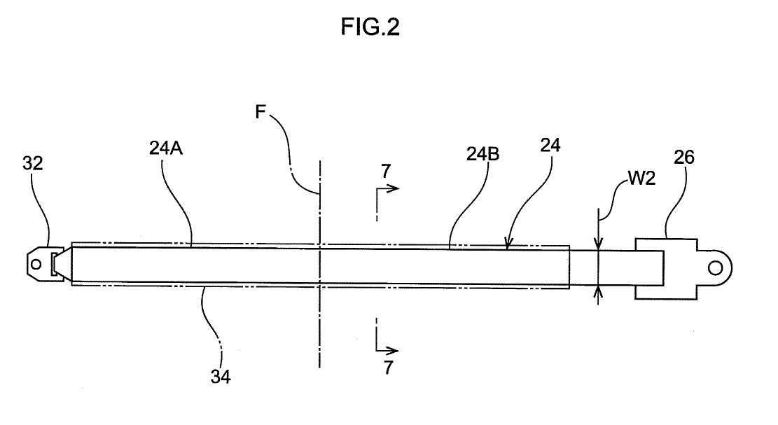

As illustrated in FIG. 1 and FIG. 2, the seatbelt device 10 includes the webbing 24, the webbing take-up device 26 that takes up the webbing 24, the tongue 28 that includes an insertion hole through which the webbing 24 is inserted, the anchor 32 that supports an end portion of the webbing 24, and an airbag 34 that is attached to the webbing 24.

As illustrated in FIG. 2, the webbing 24 is formed in an elongated belt shape, and an end portion on one side of the webbing 24 is fixed to the anchor 32. An end portion on the other side of the webbing 24 is fixed to a spool, not illustrated in the drawings, of the webbing take-up device 26. The webbing 24 is taken up and stored inside the webbing take-up device 26 by rotation of the spool. As illustrated in FIG. 1, the webbing 24 is pulled out from the webbing take-up device 26, and the tongue 28 through which the webbing 24 is inserted is supported by the buckle 30 such that the webbing 24 spans between the left side and the right side of the seat 12. The webbing 24 is thus worn over the body of the occupant P sitting in the seat 12. In a vehicle emergency (for example in a collision), the webbing take-up device 26 locks against the webbing 24 from being pulled out from the spool. Note that the physique of the occupant P sitting in the seat 12 is similar to that of an AM50 dummy, and the occupant P sits in a standard posture on the seat 12 that is set in a standard use state.

In a state in which the webbing 24 is being worn by the occupant P sitting on the seat 12, the webbing 24 is folded back about a portion inserted through the tongue 28. A portion of the webbing 24 between the tongue 28 and the anchor 32 configures lap webbing 24A (a lap belt) that supports the abdomen of the occupant P, and a portion of the webbing 24 between the shoulder anchor 27 and the tongue 28 configures shoulder webbing 24B (a shoulder belt) that supports the occupant P over a region from the abdomen to the shoulder.

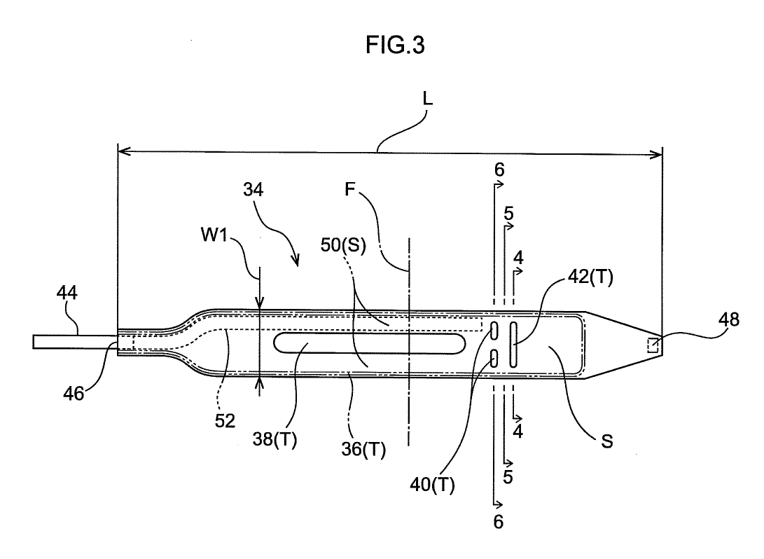

As illustrated in FIG. 3, the airbag 34 is formed in a rectangular shape with its length direction running along the same direction as the length direction of the webbing 24 (see FIG. 2). The airbag 34 is formed by weaving a stitch-free piece of cloth with a portion that inflates when internally supplied with gas (inflating portion S) and portions T that do not inflate. Specifically, an outer peripheral end portion 36, a partitioning wall portion 38, first island portions 40, and a second island portion 42, described later, of the airbag 34 configure the portions T that do not inflate. Locations other than the portions T that do not inflate have two layers in the thickness direction of the webbing 24, such that these locations (the inflating portion S) can be inflating when the airbag 34 is internally supplied with gas.

As illustrated in FIG. 2 and FIG. 3, a length direction dimension L of the airbag 34 is a dimension corresponding to a length of the shoulder webbing 24B that supports the occupant P over a region from the abdomen to the shoulder. A short direction dimension W1 of the airbag 34 is set as a wider dimension than a width W2 of the webbing 24. Note that the line F in the drawings illustrates a position where the webbing 24 and the airbag 34 attached to the webbing 24 are folded back around about the tongue 28.

As illustrated in FIG. 3, an end portion on one length direction side of the airbag 34 is formed so as to narrow gradually on progression in a direction toward the one length direction side, and the end on the one length direction is formed with an entry port 46 for introducing gas generated by an inflator 44 inside the airbag 34 in a vehicle emergency state (for example in a collision). An end portion on the other length direction side of the airbag 34 is formed so as to narrow gradually on progression in a direction toward the other length direction side, and the other length direction side of the airbag 34 is closed off. Note that the end portion on the other length direction side of the airbag 34 is configured by a stitching portion 48 that is stitched to the webbing 24.

The partitioning wall portion 38 extending along the length direction of the airbag 34 is provided at a short direction intermediate portion of the airbag 34. The partitioning wall portion 38 extends across a range corresponding to the lap webbing 24A to the shoulder webbing 24B, and the partitioning wall portion 38 is configured as a portion T that does not inflate using the manufacturing method described above. Namely, the partitioning wall portion 38 configures a portion whose thickness direction dimension does not change accompanying the supply of gas into the airbag 34.

Portions on either side of the partitioning wall portion 38 have two layers in the thickness direction of the webbing 24, as described above. Accordingly, the portions on either side of the partitioning wall portion 38 inflate when gas is supplied inside the airbag 34. Note that in the portions on either side of the partitioning wall portion 38, spaces through which gas flows are referred to as main flow paths 50. An inner tube 52 is inserted through the main flow path 50 on one side, and the flow of gas generated by the inflator 44 through the inner tube 52 to the shoulder webbing 24B side is prioritized. Note that whether or not the inner tube 52 is provided may be set as appropriate in consideration of inflation characteristics (the inflation process) and the like of the airbag 34.

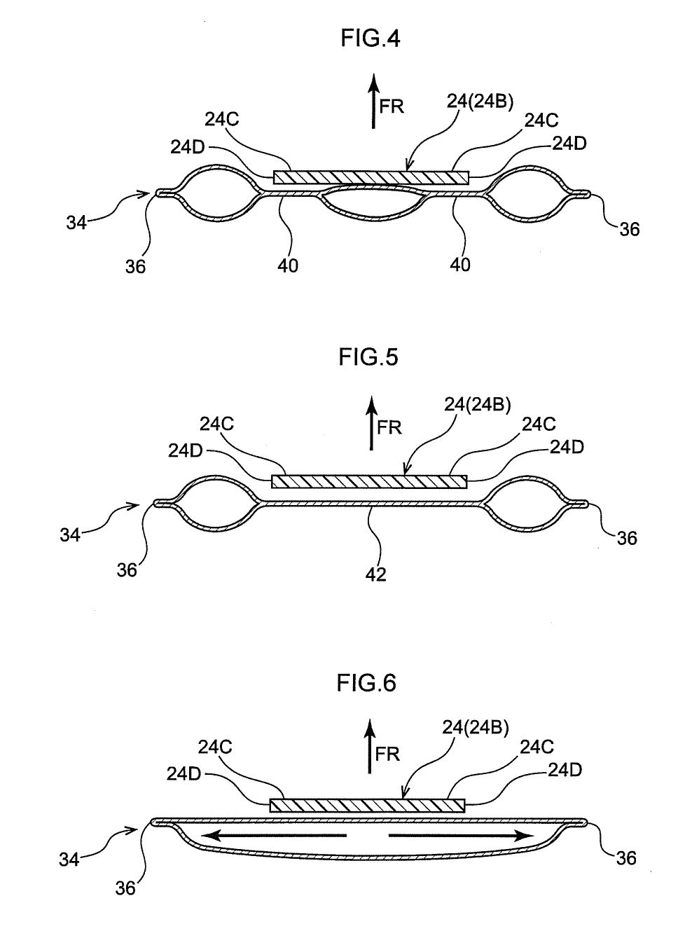

The first island portions 40 are provided at the airbag 34 further to a webbing take-up device 26 (see FIG. 2) side from the partitioning wall portion 38. The first island portions 40 are each formed in an elongated shape with length direction along the width direction of the webbing 24, and the two first island portions 40 are disposed with a space between each other in the width direction of the webbing 24. Moreover, as illustrated in FIG. 4, in a deployed state of the airbag 34, namely, in an inflated state of the inflating portion S, the two first island portions 40 are disposed alongside edge portions 24C in the width direction of the webbing 24. In the deployed state of the airbag 34, the first island portions 40 overlap with edges 24D of the webbing 24 as viewed along the thickness direction of the webbing 24. Namely, the first island portions 40 are located over the edges 24D of the webbing 24 as viewed along the thickness direction of the webbing 24. Note that the configuration of the first island portions 40 is similar to the configuration of the partitioning wall portion 38, such that the first island portions 40 configure portions whose thickness direction dimension does not change accompanying the supply of gas into the airbag 34.

As illustrated in FIG. 3, the second island portion 42 is provided at the airbag 34 further to the webbing take-up device 26 (see FIG. 2) side from the first island portions 40. The second island portion 42 crosses in the width direction of the webbing 24 and is formed with an elongated shape longer than that of the first island portions 40. The second island portion 42 is disposed alongside the first island portions 40 in the length direction of the webbing 24. Moreover, as illustrated in FIG. 5, in the deployed state of the airbag 34, namely, in an inflated state of the inflating portion S, the second island portion 42 is disposed alongside both edge portions 24C in the width direction of the webbing 24. In the deployed state of the airbag 34, the second island portion 42 overlaps with the webbing 24 as viewed along the thickness direction of the webbing 24. Namely, the second island portion 42 is located over the webbing 24 in the width direction as viewed along the thickness direction of the webbing 24. Note that the configuration of the second island portion 42 is similar to the configuration of the partitioning wall portion 38 and the first island portions 40, such that the second island portion 42 configures a portion whose thickness direction dimension does not change accompanying the supply of gas into the airbag 34.

As illustrated in FIG. 1 and FIG. 3, the first island portions 40 and the second island portion 42 are disposed at positions facing the chest of the occupant P in a state in which the occupant P is wearing the webbing 24.

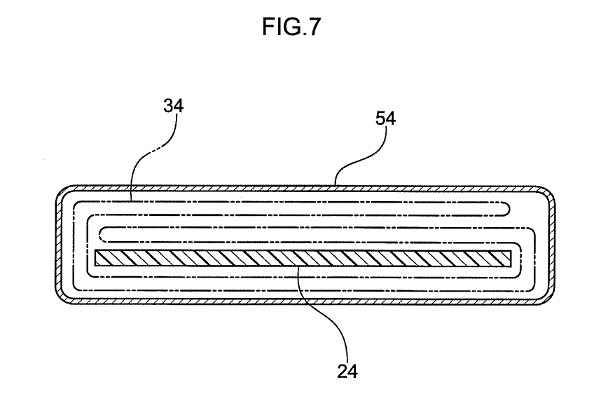

As illustrated in FIG. 7, the airbag 34 is folded such that the short direction intermediate portion of the airbag 34 described above is disposed on an occupant P side of the webbing 24, and both short direction end portions of the airbag 34 are then folded around to an opposite side of the webbing 24 to the occupant P. The airbag 34 is then covered by a cover member 54 in a state the airbag 34 and the webbing 24 are in close contact with each other. The airbag 34 is thereby attached to the webbing 24. The strength of the cover member 54 is set such that the cover member 54 splits during deployment of the airbag 34.

### Operation and Advantageous Effects of the Present Exemplary Embodiment

Next, explanation follows regarding operation and advantageous effects of the present exemplary embodiment.

As illustrated in FIG. 1, in a state in which the webbing 24 is being worn by the occupant P, when gas is supplied into the airbag 34, the inflating portion S (see FIG. 3) of the airbag 34 inflates and the airbag 34 deploys between the webbing 24 and the occupant P (the seat 12). When the inflating portion S of the airbag 34 inflates, namely, when the airbag 34 deploys, as illustrated in FIG. 4 and FIG. 5, the first island portions 40 and the second island portion 42 formed at the airbag 34 are disposed alongside the edge portions 24C of the webbing 24. Gas flowing along the length direction of the webbing 24 inside the airbag 34 collides with the first island portions 40 and the second island portion 42. In other words, the pressure of the gas increases in the vicinity of the first island portions 40 and the second island portion 42. Accordingly, the airbag 34 can be suppressed from kinking at the vicinity of the first island portions 40 and the second island portion 42, namely at the width direction edge portions 24C of the webbing 24, as a kinking start position, when the occupant P presses the inflating and deploying airbag 34 toward a webbing 24 side. Moreover, the gas that collides with the first island portions 40 and the second island portion 42 flows toward the width direction of the belt, thereby enabling improved deployment performance of the airbag 34 in the width direction of the webbing 24. This thereby enables load input to the occupant P from the airbag 34 to be effectively dispersed. Moreover, a thickness of the airbag 34 can be reduced from being locally inflated, enabling a reduction in the load input from the airbag 34 to the occupant P.

The present exemplary embodiment enables gas pressure to be raised in the vicinity of a location in the airbag 34 where the first island portions 40 and the second island portion 42 are provided so as to be across both edges 24D of the webbing 24. Namely, the gas pressure can be raised at locations of the airbag 34 which is in the vicinity of both edges 24D of the webbing 24. Such locations are liable to act as kinking starting points. This thereby enables the airbag 34 to be suppressed from kinking at both edges of the webbing 24.

In the present exemplary embodiment, the first island portions 40 and the second island portion 42 are formed in elongated shapes along the width direction of the webbing 24, thereby enabling the gas that has collided with the first island portions 40 and the second island portion 42 to flow smoothly along the length direction of the first island portions 40 and the second island portion 42. This thereby enables stable deployment performance of the airbag 34 in the width direction of the webbing 24. Moreover, forming the first island portions 40 and the second island portion 42 in elongated shapes along the width direction of the webbing 24 facilitates bending of the airbag 34 at the first island portions 40 and the second island portion 42 as bending starting position in the length direction of the webbing 24. This thereby enables the airbag 34 to be deployed conforming to the body (chest) of the occupant P.

In the present exemplary embodiment, due to disposing the two first island portions 40 and the second island portion 42 as described above, gas flowing between the two first island portions 40 collides with the second island portion 42, and gas that has collided with the second island portion 42 flows toward the width direction of the belt between the first island portions 40 and the second island portion 42, as illustrated in FIG. 6. This thereby enables improved deployment performance of the airbag 34 in the width direction of the webbing 24 at a location between the first island portions 40 and the second island portion 42. Namely, deployment performance of the airbag 34 can be improved at a location facing the chest of the occupant P.

Note that in the present exemplary embodiment, explanation has been given regarding an example in which the airbag 34 is provided with the first island portions 40 and the second island portion 42 configured as described above; however, the present invention is not limited thereto. For example, configuration may be made in which plural island portions configured similarly to the second island portion 42 are provided along the length direction of the webbing 24. Moreover, in the present exemplary embodiment, explanation has been given regarding an example in which the airbag 34 is provided with the first island portions 40 and the second island portion 42 formed in elongated shapes along the width direction of the webbing 24; however, the present invention is not limited thereto. The shapes of the island portions may be set as appropriate in consideration of, for example, the pressure distribution of gas flowing in the airbag 34. Moreover, in the present exemplary embodiment, explanation has been given regarding an example in which the first island portions 40 and the second island portion 42 are disposed alongside both edge portions 24C in the width direction of the webbing 24; however, the present invention is not limited thereto, and, for example, configuration may be made in which the first island portions 40 and the second island portion 42 are configured disposed alongside the edge portion 24C on one side in the width direction of the webbing 24. Moreover, in the present exemplary embodiment, explanation has been given regarding an example in which the first island portions 40 and the second island portion 42 are formed with symmetry in the width direction of the webbing 24; however, the present invention is not limited thereto, and, for example, the airbag may be formed with island portions that are asymmetrical in the width direction of the webbing 24.

In the present exemplary embodiment, explanation has been given regarding an example in which the island portions (the first island portions 40 and the second island portion 42) are provided at the airbag 34 using the manufacturing method described above; however, the present invention is not limited thereto. For example, tethers may be provided so as to make island portions at the locations provided with the tethers, or stitching may be performed so as to make island portions at the stitched locations. Namely, other methods may be employed that enable dimensional change in the thickness direction of the webbing to be set smaller than the dimensional change of the inflating portion in the thickness direction of the webbing when the airbag is internally supplied with gas.

### Modified Example of the Above Exemplary Embodiment

Next, explanation follows regarding an airbag 56 according to a modified example of the above exemplary embodiment. Note that members and portions that are the same or similar to those of the above exemplary embodiment are allocated the same reference numerals as in the above exemplary embodiment, and explanation thereof is omitted.

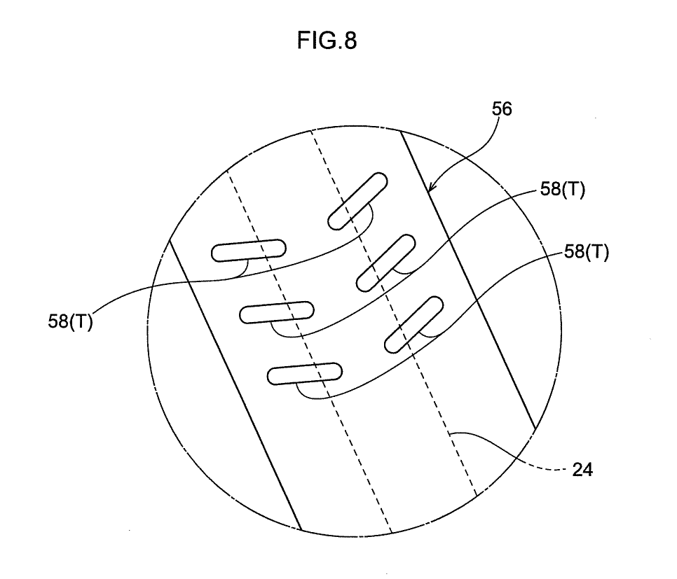

As illustrated in FIG. 8, the airbag 56 of the present modified example is provided with plural pairs of island portions 58, corresponding to the pair of first island portions 40 of the exemplary embodiment described above, along the length direction of the webbing 24. The pairs of island portions 58 are angled with respect to the length direction of the webbing 24. Namely, inside end portions of the respective pairs of island portions 58 in the width direction of the webbing 24 are positioned further to the one length direction side of the webbing 24 than outside end portions in the width direction of the webbing 24.

The airbag 56 according to the modified example described above enables deployment characteristics of the airbag 56 in the width direction and the length direction to be regulated easily by adjusting the angles of the pairs of island portions 58 with respect to the length direction of the webbing 24.

Explanation has been given above regarding an exemplary embodiment of the present invention; however the present invention is not limited to the above description, and obviously various modifications may be implemented within a range not departing from the spirit of the present invention.

The disclosure of Japanese Patent Application No. 2013-251327 is incorporated in its entirety by reference herein.

All cited documents, patent applications and technical standards mentioned in the present specification are incorporated by reference in the present specification to the same extent as if the individual cited document, patent application, or technical standard was specifically and individually indicated to be incorporated by reference.

1. A seatbelt device comprising:
webbing configured to be worn by an occupant sitting in a vehicle seat; and
an airbag attached to the webbing, the airbag including an inflating portion that inflates due to being internally supplied with gas, and an island portion, the island portion being set with a smaller dimensional change than the inflating portion in a thickness direction of the webbing when internally supplied with gas and being disposed at a position at a side of a width direction edge portion of the webbing and facing a chest of the occupant in an inflated state of the inflating portion;
wherein the airbag deploys in a width direction of the webbing between the webbing and the occupant due to inflation of the inflating portion.

2. The seatbelt device of claim 1, wherein the island portion overlaps with a width direction edge of the webbing as viewed along the thickness direction of the webbing.

3. The seatbelt device of claim 1, wherein the island portion is formed in an elongated shape with its length direction along the width direction of the webbing.

4. The seatbelt device of claim 1, wherein:
the island portion is configured by a plurality of first island portions provided with a spacing between each other in the width direction of the webbing, and a second island portion formed in an elongated shape running across in the width direction of the webbing; and
the second island portion is disposed alongside the first island portion in a length direction of the webbing.
